(19) United States
(12) Patent Application Publication
(10) Pub. No.: US 2001/0014380 A1
(43) Pub. Date: Aug. 16, 2001

(54) Multilayer molded articles

(76) Inventors: Yoshitaka Kobayashi, Ibaraki-shi (JP); Nobuhiro Usui, Takatsuki-shi (JP)

Correspondence Address: FITCH EVEN TABIN AND FLANNERY, 120 SOUTH LA SALLE STREET, SUITE 1600, CHICAGO, IL, 606033406

(21) Appl. No.: 09/770,502

(22) Filed: Jan. 29, 2001

(30) Foreign Application Priority Data
Feb. 16, 2000 (JP) 2000-037588

(51) Int. Cl. B32B 23/02

(52) U.S. Cl. 428/192

(57) ABSTRACT

The present invention provides a multilayer molded article comprising at least two skin materials attached in once piece to the surface of base materials made of thermoplastic resin by mutual contact of the two skin materials in overlapped edge(s), said two skin materials being adjacent, wherein the base material on the back of one skin material and the base material on the back of the other skin material are integrated in one piece by fusion in at least one of the overlapped edges of the adjacent two skin materials, such that the end of the overlapped edge of the two skin materials bent toward the base materials is enclosed by plural ribs provided in the overlapped edge of the two skin materials on the back of the base materials, said multilayer molded article wherein the base materials are integrated reliably to the skin materials and the base materials on the back of each skin material are mutually integrated strongly to achieve high strength and excellent appearance, so that the multilayer molded article has high strength and excellent in appearance and can thus be used in a wide variety of utilities including interior parts in automobiles.

### BACKGROUND OF THE INVENTION

1. Field of the Invention

The present invention relates to a multilayer molded article comprising at least two skin materials attached in once piece to the surface of base materials made of thermoplastic resin by mutual contact of the two skin materials in overlapped edge(s).

2. Description of the Prior Art

Heretofore, multilayer molded articles having skin materials attached to the surface of base materials made of thermoplastic resin have been used in a wide variety of fields such as interior parts (e.g. door trims and instrument panels) in automobiles and interior and exterior parts in household appliances.

As such multilayer molded articles, there is a demand for multilayer molded articles having two skin materials attached to the surface of base materials made of thermoplastic resin by mutual contact of the skin materials in an overlapped edge, in order to meet diversified needs in recent years.

In a method for obtaining such multilayer molded articles, two parts each having a single skin material attached to the surface of a base material made of thermoplastic resin are separately produced by conventional techniques such as injection molding and compression molding, and both the parts are integrated by a fitting means or a screw at an edge of their base materials and, if needed, further integrated by heat-fusion at the edge, as shown in FIG. 12, or alternatively, by attaching one skin material to the surface of thermoplastic resin by injection molding or compression molding, and overlapping another skin material therewith and attaching it thereto via an adhesive etc. (FIG. 13).

However, the multilayer molded article produced by the former method has a poor bonding power because of the inadequate joining of the two base materials. In case where heat fusion is applied for producing the multilayer molded article, the base materials themselves are deformed due to direct heating of the parts after molding, or the skin materials are deformed due to heating of the base materials, thus deteriorating the outward appearance. While the multilayer molded article is produced by the latter method, there is a problem of removal of the skin materials, etc.

### SUMMARY OF THE INVENTION

Under such circumstances, the present inventors studied for developing a multilayer molded article comprising at least two skin materials attached to the surface of base materials made of thermoplastic resin by mutual contact of the two skin materials in overlapped edge(s), wherein the base materials are integrated reliably to the skin materials and the base materials on the back of each skin material are mutually integrated strongly to achieve high strength and excellent appearance, and as a result, the inventors reached the present invention.

The present invention provides a multilayer molded article comprising at least two skin materials attached in once piece to the surface of base materials of thermoplastic resin by mutual contact of the two skin materials in overlapped edge(s), said two skin materials being adjacent, wherein the base material on the back of one skin material and the base material on the back of the other skin material are integrated in one piece by fusion in at least one of the overlapped edges of the two skin materials, such that the end of the overlapped edge of the two skin materials bent toward the base materials is enclosed by plural ribs provided in the overlapped edge of the two skin materials on the back of the base materials.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step.

### BRIEF DESCRIPTION OF THE DRAWINGS

FIG. 1 shows a plan view of one example of the multilayer molded article of the present invention when viewed from the side of the skin material.

FIG. 2 shows the multilayer molded article shown in FIG. 1 when viewed from the back thereof.

FIG. 3 is an A-A sectional view of the multilayer molded article shown in FIG. 2.

FIG. 4 is a B-B sectional view of the multilayer molded article shown in FIG. 2.

FIG. 5 is a C-C sectional view of the multilayer molded article shown in FIG. 2.

FIG. 6 shows another example of the multilayer molded article shown in FIG. 1 when viewed from the back thereof.

FIG. 7 shows another example of the multilayer molded article shown in FIG. 1 when viewed from the back thereof.

FIG. 8 shows another example of the multilayer molded article shown in FIG. 1 when viewed from the back thereof.

FIG. 9 is a D-D sectional view of the multilayer molded article shown in FIG. 8.

FIG. 10 is an E-E sectional view of the multilayer molded article shown in FIG. 8.

FIG. 11 is an F-F sectional view of the multilayer molded article shown in FIG. 8.

FIG. 12 shows one example of a partial section of a multilayer molded article in the prior art.

FIG. 13 shows another example of a partial section of a multilayer molded article in the prior art.

FIG. 14 shows a plan view of one example of the multilayer molded article of the present invention having three skin materials attached therein.

### DETAILED DESCRIPTION OF THE INVENTION

Hereinafter, the present invention is described in detail by reference to the drawings.

The following description is one example of the present invention, which is not intended to limit the present invention.

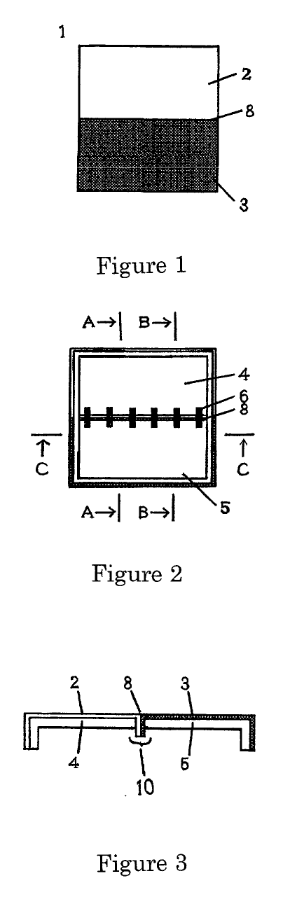

FIG. 1 is a plan view of one example of the multilayer molded article (1) of the present invention having two skin materials attached in one piece to the surface of base materials made of thermoplastic resin by mutual contact of the two skin materials in their overlapped edges, and wherein a first skin material (2) is attached to the surface of one base material and a second skin material (3) is attached to the surface of the other base material, and both are attached in one piece to the surface of base materials by mutual contact of the two skin materials in overlapped edge (8) thereof without using an adhesive therebetween.

FIG. 2 shows the multilayer molded article (1) shown in FIG. 1 when viewed from the back thereof. The base material (4) on the back of the first skin material (2) and the base material (5) on the back of the second skin material (3) are provided with plural ribs (6) in the overlapped edge (8) of each skin material on the back of each base material, and both the base materials are integrated in one piece by fusion in the overlapped edge of the two skin materials such that the end (10) of the two skin materials bent toward the base material is enclosed by the ribs.

In the drawings of the present application including FIG. 2, ribs (6) are smeared so as to be easily recognized and distinct from the base materials, but actually each rib is fused into the base material and integrated completely in once piece.

FIGS. 3, 4 and 5 illustrate this state.

FIG. 3 shows a section (along line A-A shown in FIG. 2) of the multilayer molded article shown in FIG. 2, where the base material (4) on the back of the first skin material (2) and the base material (5) on the back of the second skin material (3) are not connected via the ribs (6), and in this part, the first skin material (2) and the second skin material (3) are present between their base materials, thus separating the base materials form each other.

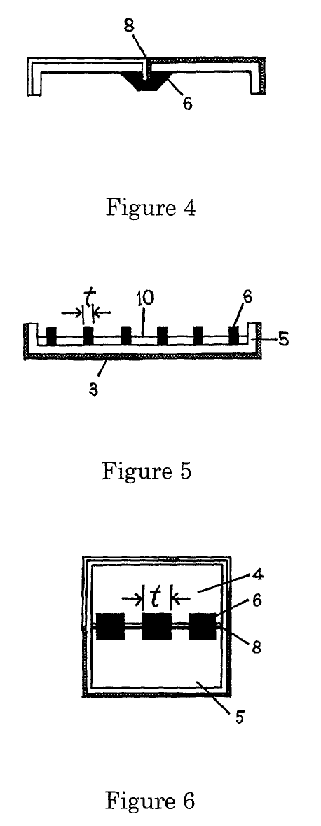

FIG. 4 shows a section (along line B-B shown in FIG. 2) of the multilayer molded article shown in FIG. 2, where the base material (4) on the back of the first skin material (2) and the base material (5) on the back of the second skin material (3) are connected via the ribs (6). As shown in the drawing, each rib (6) is provided such that the end (10) of the skin materials in the overlapped edge of the first and second skin materials is enclosed by the width (t) of the rib, and their base materials are thereby integrated in one piece via each rib.

FIG. 5 is a sectional view (along line C-C shown in FIG. 2) of the multilayer molded article shown in FIG. 2, showing connections with the ribs (6) when viewed from the side of the base material (5) on the back of the second skin material (3), and the ribs (6) integrated into both the base materials are arranged at suitable intervals.

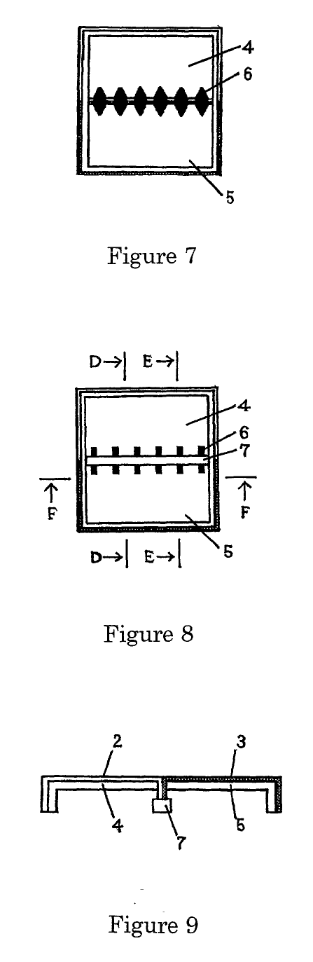

The form of the rib is not particularly limited insofar as the base materials can be integrated in once piece via the rib (6). The rib (6) for integrating both the base materials may has a broad width as shown in FIG. 6 or a varying width as shown in FIG. 7. These ribs may further be in the form of a combination of ribs of different shapes.

The ribs (6) may also be arranged at intervals such that the strength of the product is not lowered, and the interval (i.e. distance) between the ribs may be determined depending on the shape of the product and the width and shape of each rib. Therefore, the ribs (6) may be arranged at regular intervals or varying intervals. However, if the width (t) of the rib is too broad, sink marks occur easily on the surface of the product upon molding, or the overlapped edge of the two skin materials may slide to allow the overlapped edge to meander often. While if the width is too narrow, the strength of the product tends to be insufficient. Accordingly, it is preferable for outward appearance and strength that the width of the rib is made broader within such a range as not to cause sink marks on the surface of the product or a meandering overlapped edge of the skin materials.

FIG. 8 shows an example of the multilayer molded article (1) in case where the base material (4) on the back of the first skin material (2) and the base material (5) on the back of the second skin material (3) are integrated by another method.

In the embodiment shown in FIG. 8, the base material (4) on the back of the first skin material (2) and the base material (5) on the back of the second skin material (3) are connected via the ribs (6), and simultaneously the ribs are successively integrated by fusion via a resin mass (7) provided at the top of each rib, thus endowing the product with higher strength as a whole than by connection via only the ribs (6), to provide a referable embodiment.

FIG. 9 shows a sectional view (section along line D-D shown in FIG. 8) of the multilayer molded article shown in FIG. 8, in case where the base material (4) on the back of the first skin material (2) and the base material (5) on the back of the second skin material (3) are not connected via the ribs (6), and in this part, the base materials 4 and 5 are completely separated from each other while the resin mass (7) is present in an independent state in the vicinity of the skin-material edge (10) of the overlapped edge of the 2 skin materials.

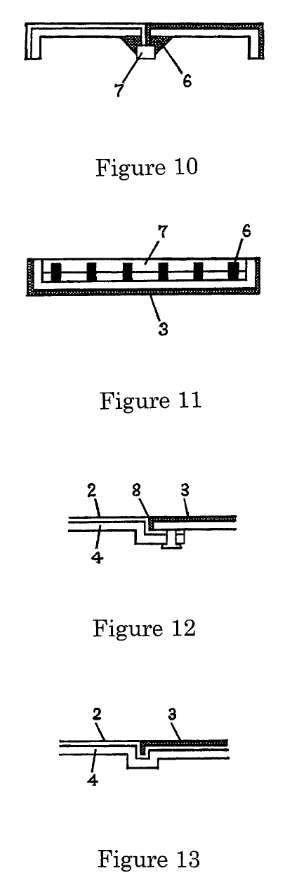

FIG. 10 shows a section (section along line E-E shown in FIG. 8) of the multilayer molded article shown in FIG. 8, in case where the base material (4) on the back of the first skin material (2) and the base material (5) on the back of the second skin material (3) are connected via the ribs (6), and each material is integrated in one piece via the ribs while each rib (6) is integrated further strongly by connection to the resin mass (7).

FIG. 11 shows a sectional view (section along line F-F shown in FIG. 8) of the multilayer molded article shown in FIG. 8, showing connections with the ribs (6) when viewed from the side of the base material (5) on the back of the second skin material (3), in case where the ribs are arranged at suitable intervals to connect both the base materials and simultaneously the ribs are successively integrated by connection to the resin mass, while both sides of the resin mass are further connected to the lengthwise walls of the multilayer molded article (1), thus conferring higher strength on the product. In FIGS. 8 to 11, the ribs (6) are smeared to make the ribs distinct from the resin mass (7) and to clarify the relationship therebetween, but actually each rib, the base materials and the resin mass have been completely integrated in one piece.

Because a larger size of the resin mass (7) leads to an increase in the weight and cost of the product, the resin mass is preferably smaller within such a range as to permit as the strength of the product to be maintained. Furthermore, this resin mass may be completely separated from the end of the two skin surface materials, or the end of the two skin materials may be partially embedded in the resin mass.

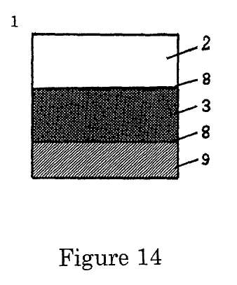

In the foregoing description, the multilayer molded article having two skin materials attached therein has been described, but the number of the skin materials in the present invention is not limited to two. As far as the different skin materials may be attached and integrated in one piece by mutual contact in overlapped edges with the structure described above, three skin materials may be attached as shown in FIG. 14, and as a matter of course, four or more skin materials may be attached by contact in a plurality of overlapped edges of the skin materials.

When three or more skin materials are attached by mutual contact in overlapped edges in the multilayer molded article of the present invention, the base materials should have been integrated by fusion in at least one of the overlapped edges by the above-described rib structure. But, depending on the intended use of the multilayer molded article, it is not necessary that the base materials should have been integrated by fusion in the remaining overlapped edges, and therefore, the base materials may have been integrated by joining techniques known in the art.

For example, the multilayer molded article having three skin materials attached therein as shown in FIG. 14 has two overlapped edges, that is, the edge between the skin materials (2) and (3) and the edge between the skin materials (3) and (9), and one of the two overlapped edges may have been integrated by conventional joining techniques.

The skin materials used in the multilayer molded article of the present invention include textiles and knitted webs such as moquette and tricot, nonwoven fabrics such as needle punch carpets, metal foils, and sheets and films of thermoplastic resins and sheets and films of thermoplastic elastomers.

Although the skin material may be, as needed, a two-layer or more laminated skin material having a foamed layer or a backing layer laminated therein, the skin material should be capable of being heat-fused with thermoplastic resin or being impregnated on the back thereof with thermoplastic resin in a molten state, thus being permitted to be bonded in one piece to the base material.

In this case, the foamed sheet includes foams of polyolefins such as polypropylene and polyethylene, polyvinyl chloride foams, and soft or semirigid polyurethane foams.

The backing layer includes nonwoven fabrics and sheets and films of synthetic resin. The fibers constituting the nonwoven fabrics includes natural fibers such as cotton, hair, silk and hemp or synthetic resin fibers such as polyamine fiber, polyester fiber and nylon fiber. These fibers are used alone, or nonwoven fabrics produced by blending these fibers are used. Examples of the nonwoven fabrics are those produced by needle punching, thermal bonding, spun bonding, melt blowing or spun lacing. The sheets and films of synthetic resin include sheets and films made of thermoplastic resins such as polypropylene and polyethylene or of polyolefin-based thermoplastic elastomers. These should be capable of being heat-fused with the thermoplastic resin used as the base material resin.

In the present invention, the “at least two skin materials” include not only those different in their materials, but also those different in color, design or texture made of the same material.

The thermoplastic resin used in the present invention is a resin usually used in compression molding, injection molding, extrusion molding etc., and includes e.g. general thermoplastic resins such as polypropylene, polyethylene, acrylonitrile-styrene-butadiene block copolymers, polystyrene, polyamides such as nylon, polyvinyl chloride, polycarbonate, acrylic resin, and styrene-butadiene block copolymers, thermoplastic elastomers such as EPM and EPDM, mixtures thereof, and polymer alloys using these resins, which may be non-formable or formable.

Further, these thermoplastic resins may contain, if needed, glass fibers, various inorganic or organic fillers used usually. Further, various additives such as pigments, lubricants, antistatic agents and stabilizers may also be blended therewith.

The multilayer molded article of the present invention can be produced easily by conventional molding techniques such as injection molding, injection pressing, and compression molding by means of a mold comprising a pair of male and female mold, said molds forming a cavity constituting a predetermined product shape, having a pinching portion capable of pinching the end of the two skin materials in the overlapped edge of the skin materials, and having concaves for forming the ribs. In injection molding, however, the skin materials are heated and pressurized directly by a melted resin supplied, so a significant damage to the skin materials is caused. Accordingly, injection pressing molding or extrusion molding wherein the damage to the skin materials can be reduced by clamping after supplying the melted resin can be used more preferably.

The multilayer molded article of the present invention comprises at least two skin materials attached in once piece to the surface of base materials made of thermoplastic resin by mutual contact of the two skin materials in an overlapped edge(s), said two skin materials being adjacent, wherein the skin materials are bonded reliably to the base materials while the base material on the back of one skin material and the base material on the back of the other skin material are integrated in one piece by fusion in at least one of overlapped edged of the two skin materials, so that the multilayer molded article has high strength and excellent in appearance and can thus be used in a wide variety of utilities including interior parts in automobiles.

What is claimed is:

1. A multilayer molded article comprising at least two skin materials attached in once piece to the surface of base materials made of thermoplastic resin by mutual contact of the two skin materials in overlapped edge(s), said two skin materials being adjacent, wherein the base material on the back of one skin material and the base material on the back of the other skin material are integrated in one piece by fusion in at least one of the overlapped edges of the adjacent two skin materials, such that the end of the overlapped edge of the two skin materials bent toward the base materials is enclosed by plural ribs provided in the overlapped edge of the two skin materials on the back of the base materials.

2. The multilayer molded article according to claim 1, wherein the ribs are mutually integrated by fusion successively at the top of each rib.
